(19) United States
(12) Patent Application Publication
(10) Pub. No.: US 2024/0308316 A1
(43) Pub. Date: Sep. 19, 2024

(54) VEHICLE WINDSHIELD PROTECTION SECURITY STRAP AND SUCTION CUP DEVICE

(71) Applicant: Delk Industries, Inc, Portland, OR (US)

(72) Inventors: Yueqi Wang, Nashville, TN (US); Raymond Don Barnes, JR., Nashville, TN (US); Cory Thomas Jackson, Nashville, TN (US)

(73) Assignee: Delk Industries, Inc, Portland, TN (US)

(21) Appl. No.: 18/183,749

(22) Filed: Mar. 14, 2023

(51) Int. Cl. B60J 11/08

(52) U.S. Cl. CPC B60J 11/08

(57) ABSTRACT

A windshield cover comprising a main cover portion, one or more security straps, and one or more suction cups. The security straps are connected to one or more edges of said main cover portion, such that the security straps are configured to pass into an interior of a vehicle when the main cover portion is placed on a windshield of the vehicle. The suction cups are attached to one of said one or more security straps and are configured to removably adhere to an interior side of a window of the vehicle, such that each of the security straps are held in place adjacent to the window.

### FIELD OF THE DISCLOSURE

The present disclosure generally relates to devices for use with a windshield covering device in order to secure a windshield covering device to a vehicle. More particularly, the present disclosure generally relates to a security strap and suction cup attached to a vehicle windshield cover. The security strap and cup secure the windshield cover to a vehicle during non-use of the vehicle, such as when it is parked. The use of the suction cup holds the security flaps in place against the side windows providing additional shade, ease of use, and concealing the contents of the vehicle.

### SUMMARY

To minimize the limitations in the prior art, and to minimize other limitations that will become apparent upon reading and understanding the present specification, the present disclosure discloses a new and useful vehicle windshield protection device.

The windshield protection device may be a windshield cover that may have one or more security straps. Approximately at the distal end of the security straps, there may be a connection strap, typically hook and loop, which may removably engage with a suction cup. Once the suction cup is engaged with the connection strap, the security strap may be inserted into a car door when the car door is open and the suction cup may be suctioned to the car window that is part of the car door that is open. In this manner, the security strap is held substantially in place on the car door window. This provides more shade and better control of the security strap.

One embodiment may be a windshield cover comprising: a main cover portion; one or more security straps; one or more suction cups; where the one or more security straps may be connected to one or more edges of said main cover portion, such that that one or more security straps may be configured to pass into an interior of a vehicle when the main cover portion is placed on a windshield of the vehicle; where each of the one or more suction cups may be attached to one of the one or more security straps; where the one or more suction cups may be configured to removably stick or adhere to an interior side of a window of the vehicle, such that each of the one or more security straps may be held in place adjacent to the window. A windshield cover, where each of the one or more suction cups may be removably attached to one of the one or more security straps. A windshield cover, where each of the one or more security straps comprises a connection strap, such that there may be one or more connection straps: where each of the one or more connection straps may be attached to one of the one or more suction cups. A windshield cover, where the one or more connection straps may be removably attached to one of the one or more suction cups. A windshield cover, where each of each one or more connection straps comprise a hook and loop material. A windshield cover, where each of the one or more suction cups comprises a hole, which may be configured to allow the one or more connection straps to removably attach to the one or more suction cups. A windshield cover, where when at least one of the one or more security straps may be held in place adjacent to the window, light may be at least partially blocked from entering through the window by the at least one of the one or more security straps. A windshield cover, where when at least one of the one or more security straps may be held in place adjacent to the window, visibility into the interior of the vehicle through said window may be at least partially blocked by at least one of the one or more security straps.

Another embodiment may be a windshield cover comprising: a main cover portion; two security straps; two suction cups; where each of the two security straps comprises a connection strap, such that there may be two connection straps: where each of the one or more connection straps may be removably attached to one of the one or more suction cups; where each of the two security straps may be connected to opposite sides of the main cover portion, such that the two security straps may be configured to pass into an interior of a vehicle when the main cover portion is placed on a windshield of the vehicle; where each of the two suction cups may be configured to removably stick or adhere to an interior side of one of two windows of the vehicle, such that the two security straps may be held in place, respectively, adjacent to the two windows. A windshield cover, where each of the two connection straps comprise a hook and loop material. A windshield cover, where each of the two suction cups comprises a hole, which may be configured to allow one of the two connection straps to removably attach to the one or more suction cups. A windshield cover, where when each of the two security straps is held in place adjacent to one of the two windows, light may be at least partially blocked from entering through the two windows by the two security straps. A windshield cover, where when each of the two security straps may be held in place adjacent to one of the two windows, visibility into the interior of the vehicle through the two windows may be at least partially blocked by the two security straps.

A windshield cover comprising: a main cover portion; a security strap; a suction cup; where the security strap comprises a connection strap; where the connection strap may be removably attached to the suction cup; where the security strap may be connected to one side of the main cover portion, such that the security strap may be configured to pass into an interior of a vehicle when the main cover portion is placed on a windshield of the vehicle; where the suction cup may be configured to removably stick or adhere to an interior side of a window of the vehicle, such that the security strap may be held in place adjacent to the window. A windshield cover, where the connection strap comprises a hook and loop material. A windshield cover, where the two suction cup comprises a hole, which may be configured to allow the connection strap to removably attach to the suction cup. A windshield cover, where when the security strap is held in place adjacent to the window, light may be at least partially blocked from entering through the window by the security strap. A windshield cover, where when the security strap may be held in place adjacent to the window, visibility into the interior of the vehicle through the window may be at least partially blocked by the security strap.

One embodiment may be a vehicle windshield cover security strap and suction cup comprising: a first security strap, a second security strap, a first silicone suction cup assembly, a second silicone suction cup assembly, a hook material, a loop material, wherein the first security strap may be configured to attach to a right side flap of a windshield cover, wherein the second security strap may be configured to attach to a left side flap of a windshield cover. The vehicle windshield cover security strap and suction cup device, wherein the first security strap comprises of nylon. The vehicle windshield cover security strap and suction cup device, wherein the second security strap comprises of nylon. The first silicone suction cup, wherein the first silicone suction cup may comprise: a flat-shaped suction cup, a rigid cup assembly, an attachment point wherein the attachment point may be configured to removably attach to the security strap. The first silicone suction cup, wherein the first silicone suction cup may be a bellows shape. The first silicone suction cup wherein the first silicone suction cup may be configured to securely hold a windshield cover to a vehicle. The second silicone suction cup, wherein the second silicone suction cup comprises: a flat-shaped suction cup, a rigid cup assembly, an attachment point, wherein the attachment point may be configured to removably attach to the second security strap. The second silicone suction cup, wherein first silicone suction cup may be a bellows shape. The second silicone suction cup, wherein the second silicone suction cup may be configured to securely hold a windshield cover to a vehicle. The hook material, wherein the hook material may be configured to fasten and reattach to the loop material. The loop material wherein the loop material may be configured to fasten and reattach to the hook material. The first security strap, further comprising: a first attachment, a no attachment space, and a second attachment point, a suction cup loop, wherein the first attachment point may be configured to attach to a right side flap, wherein the no attachment space may be configured to maintain a suction cup retaining loop, wherein the hook material may be attached to the second attachment point, wherein the loop material may be attached through the right side flap to the first attachment point of the security strap, wherein the hook material of the second attachment point may be configured to engage with said loop material, wherein the suction cup loop may be formed by the engagement of the hook material to the second attachment point and the loop material of the right side flap. The suction cup loop may be configured to loosely retain the first silicone suction cup of claim 1. The first silicon suction cup may be configured to temporarily attach the right side flap to the vehicle door window, which may be typically made of glass, wherein the temporary attachment of said the side flap obstructs a vehicle window area. The right side flap shades an internal cabin of a vehicle. The right side flap, wherein the flap does not loosely hang. The second security strap, further comprising: a first attachment, a no attachment space, and a second attachment point, a suction cup loop, wherein the first attachment point may be configured to attach to a left side flap, wherein the no attachment space may be configured maintain a suction cup retaining loop, wherein the hook material may be attached to the second attachment point, wherein the loop material may be attached through the left side flap to the first attachment point of the security strap, wherein the hook material of the second attachment point may be configured to engage with said loop material, wherein the suction cup loop may be formed by the engagement of said hook material of the second attachment point and said loop material of the left side flap. The suction cup loop may be configured to loosely retain the second silicone suction. The first silicon suction cup may be configured to temporarily attach the right side flap to the vehicle side window, wherein the temporary attachment of the right side flap obstructs a vehicle window area. The right side flap shades an internal cabin of a vehicle. The left side flap, wherein the flap does not loosely hang.

It is an object to provide a vehicle windshield protective device that remains firmly attached to a vehicle under strong winds and provides additional shade and security.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a top view of one embodiment of the vehicle windshield cover and shows the two security straps and suction cups.

FIG. 2 is an illustration of an interior view of one embodiment of the connection strap.

FIG. 3 is an illustration of a bottom perspective view of one embodiment of the suction cup.

FIG. 4 is an illustration of a close-up top view of one embodiment of security strap with a connection strap and removed suction cup.

FIG. 5 is an illustration of a close-up bottom view of one embodiment of security strap with a connection strap and removed suction cup.

FIG. 6 is an illustration of a close-upside view of one embodiment of connection strap and an attached suction cup.

FIG. 7 is an illustration of a side view of one embodiment of the vehicle windshield cover of the present disclosure showing the security strap inserted into the vehicle, and with the suction cup holding the security strap in place on the vehicle's side window.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screen shot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein the term “windshield cover” or “windshield covering” refers to any windshield protective device that is used to cover a vehicles windshield in order to provide a layer of protection to the exterior of the glass windshield.

As used herein the term “extension flap” refers to any flap, strap, section of material that may be affixed removeably or permanently to the side of a windshield cover.

As used herein the term “security strap” refers to any flap, strap, section of material that may be affixed removeably or permanently to the side of a windshield cover.

As used herein the term “rod” or “support member” refers to straight slender shaped bar or staff, made of any material such as, but not limited to, wood, metal, PVC that may be cylindrical, square, or oval in shape. It preferably has the strength and necessary stiffness needed maintain a products shape and or volume when placed on a vehicle.

As used herein the term “connection strap” refers to any elongated flap, strap, swatch, or section of material, and may be made from plastic, metal, and the like.

As used herein the term “suction cup” refers to a cup, flat, or bellows-shaped object of silicone, rubber, glass, plastic, and the like, which, by producing a partial vacuum, can be made to adhere to, stick, or draw something to a surface.

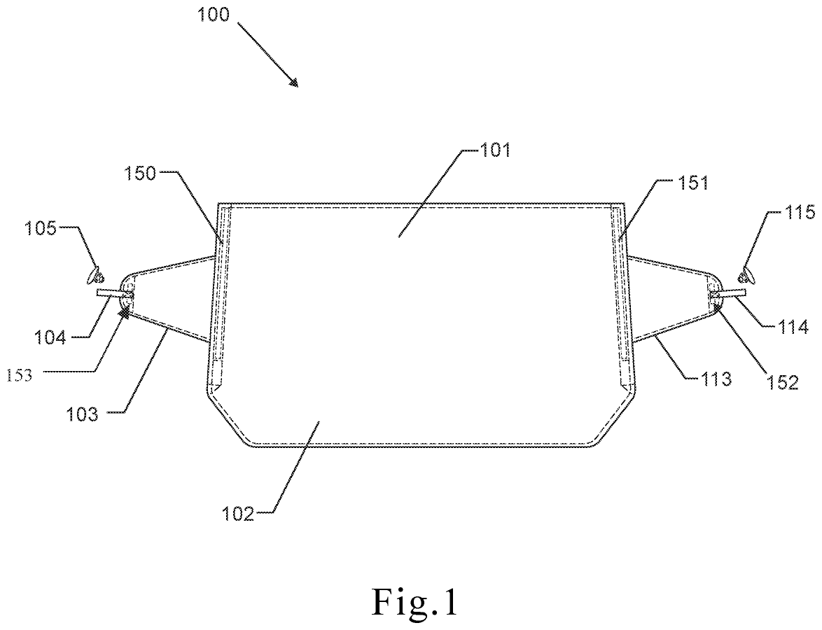

FIG. 1 is an illustration of a top view of one embodiment of the vehicle windshield cover and shows the two security straps and suction cups. FIG. 1 shows that the windshield cover 100 may comprise a wiper portion 102, a main cover portion 101, one or more security straps 103, 113, side support members 150, 151, security support members 152, 153, connection straps 104, 114, and suction cups 105, 115. Preferably, the suction cups 105, 115, are made out of silicone or some other durable plastic material. The suction cups 105, 115 are configured to be removably attached to the connection straps 104, 114. FIG. 1 shows that the security straps 103, 113 are preferably attached on opposite sides of the main cover portion 101 approximately adjacent to the support members 150, 151, which may or may not be present in the windshield cover 100. In this manner, the security straps 103, 113 may be positioned in close proximity to the A-Frame of a car door when the windshield cover 100 is placed on a vehicle windshield.

The security straps 103, 113, and the suction cups 105, 115 provide a user with more control, shading, and security after the windshield cover 100 is donned by the vehicle and the suction cups are removable stuck to the interior of the car vehicle windows.

The windshield cover 100, including the security straps 103, 113 may be made from, canvas or a plastic or cloth material that may preferably be coated with nylon or poly-10 vinyl chloride, such that the security straps 103, 113 may remain flexible in temperatures below 0° C., may be extremely durable, and water resistant.

Although the windshield cover 100 is shown with two security straps 103, 113 and two suction cups 105, 115, the windshield cover of the present disclosure may only have one security strap and one suction cup.

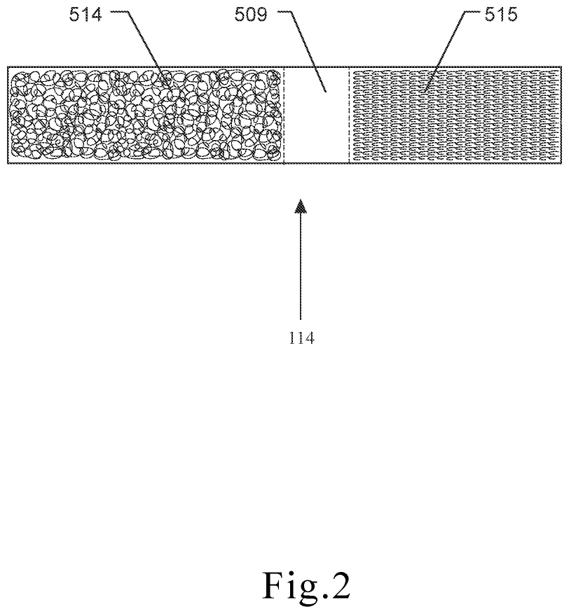

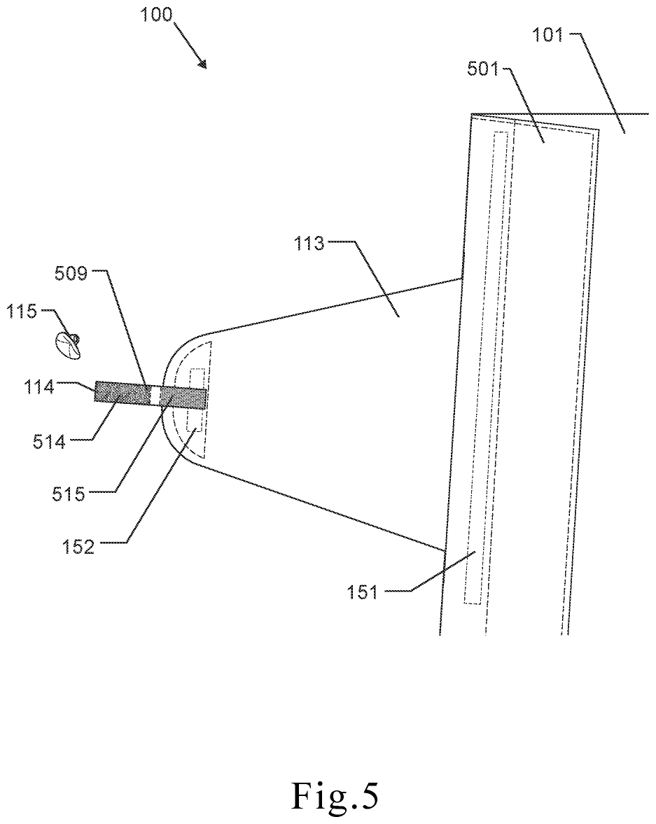

FIG. 2 is an illustration of an interior view of one embodiment of the connection strap. In one embodiment, the connection strap 114 may be approximately nine (9) centimeters in length. In other embodiments, the connection strap 114 may be longer, shorter, and or adjustable in length. As shown in FIG. 1, the connection strap 114 may comprise a hook 515 and loop 514 material on the interior side, that may be configured to fold over on itself and removably secure a suction cup in portion 509. Preferably, the hook 515 is on the distal end of the connection strap 114 and the loop 514 may be on the proximal end of the connection strap 114. But, in other embodiments the positions of the hook 515 and loop 514 may be swapped. As shown in FIG. 5, the loop 514 side of the connection strap 114 may securely attached to the distal end of security strap 113. This connection may be removeable or, as preferred, permanent, typically via sewing, ultrasonic welding, and the like. In other embodiments, the connection strap 114 may be attached to the security strap 113 on any portion of the security strap 113. Preferably the connection strap 114 may be approximately nine (9) centimeters in length, but it may be shorter or longer without deviating from the scope of the present disclosure.

In other embodiments, the hook and loop may be replaced with friction snaps, buttons, rivets, bolts, adhesives, and the like.

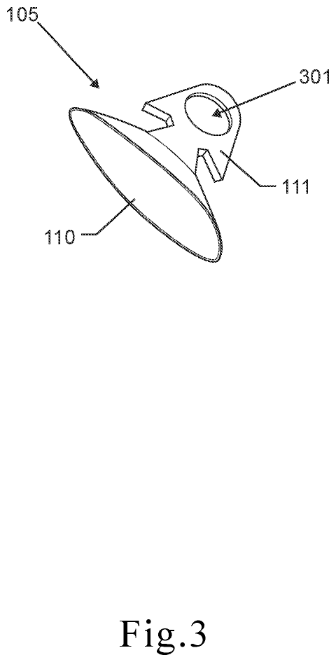

FIG. 3 is an illustration of a bottom perspective view of one embodiment of the suction cup. The suction cup 105, which may preferably be made of silicone, or some other durable and substantially flexible plastic or rubber, may comprise a flat or bellows-shaped suction cup portion 110. The preferred shape of the cup portion 110 for flat or slightly curved surfaces, such as glass, metal, and plastic sheets, is a flat vacuum cup. The cup portion 110 may have be flexible, but still have some rigidity and should be stable, so as to handle high shear forces and accelerations from fast movements. The suction cup 105 should be durable so as to not wear out too soon from the significant exposure to sunlight. The suction cup 105 may further comprise a handle attachment point 111, which may comprise hole 301, for attachment to the security strap 103 via connection strap 104. The handle attachment point 111 and hole 301 may be configured to allow the connection strap 104 to be securely, but preferably removably, attached to the suction cup 105. The handle attachment point 111 and hole 301 may comprise any formation that may be configured to securely, but removably attach the suction cup 105 to the connection strap 104. In various embodiments, the suction cup 105 may be permanently attached directly to the security strap 103 or through connection strap 104. Preferably, the suction cup 105 may be removably attached to the security strap 103 with or without the connection strap 104. The hole 301 may sometimes be referred to as a loop or ring.

With the suction cups 105, 115 attached to security straps 103, 113, security straps 103, 113, may be held security in place against the glass window of a vehicle door (typically a front door). This has the added benefits of providing shade to the internal cabin of a vehicle and at least partially obstructing the view of any onlookers thereby providing additional security to the contents of the vehicle.

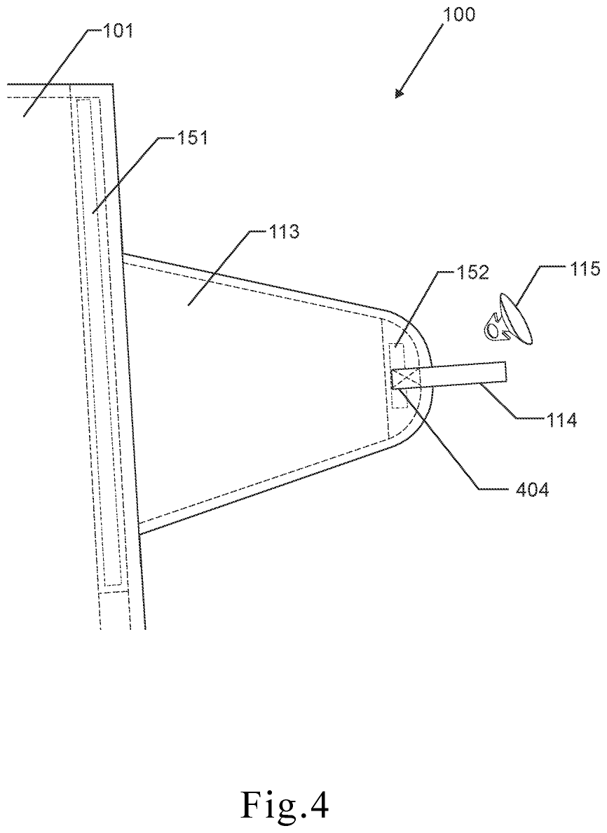

FIG. 4 is an illustration of a close-up top view of one embodiment of security strap with a connection strap and removed suction cup. As shown in FIG. 4, windshield cover 100 may comprise security strap 113, side support member 151, security support member 152, connection strap 114, suction cup 115, and main cover portion 101. Preferably security strap 113 is an extension of or permanently attached to main cover portion 101. The side support member 151 may preferably be at an edge of main cover portion 101 to provide structure and prevent the windshield cover from flapping and peeling. Although the suction cup 115 may be directly, but removably, attached to a loop perforation that is directly part of the security strap 113, preferably the suction cup 115 may be removably attached to the security strap 113 via a connection strap 114. Security strap 113 may be a nylon strap that is sewn into the top or front of security strap 113 at end 404. In one embodiment, the connection strap 114 may surround and be anchored by security support member 152 at end 404. Security support member 152 may be a PVC rod that is enclosed within the material of security strap 113 that prevents the security strap 113 from being removed from between the door frame and the vehicle A-Frame when the windshield cover 100 is on a vehicle and the door is closed. Although the connection strap 114 may be a flexible nylon strap, it should be understood that it may be a rigid loop, such as a metal ring, a fabric loop, a hole in the security strap 113, and the like, which may engage, preferably removably, with suction cup 115.

FIG. 5 is an illustration of a close-up bottom view of one embodiment of security strap with a connection strap and removed suction cup. As shown in FIG. 5, windshield cover 100 may comprise security strap 113, extension flap 501, side support member 151, security support member 152, connection strap 114, suction cup 115, and main cover portion 101.

As shown in FIG. 5, the connection strap 114 may comprise a hook 515 and loop 514 material that may be configured to fold over on itself and removably secure the suction cup 115 in portion 509. Preferably, the attached suction cup 115 is at an end of security strap 113 and is distal to the security support member 152.

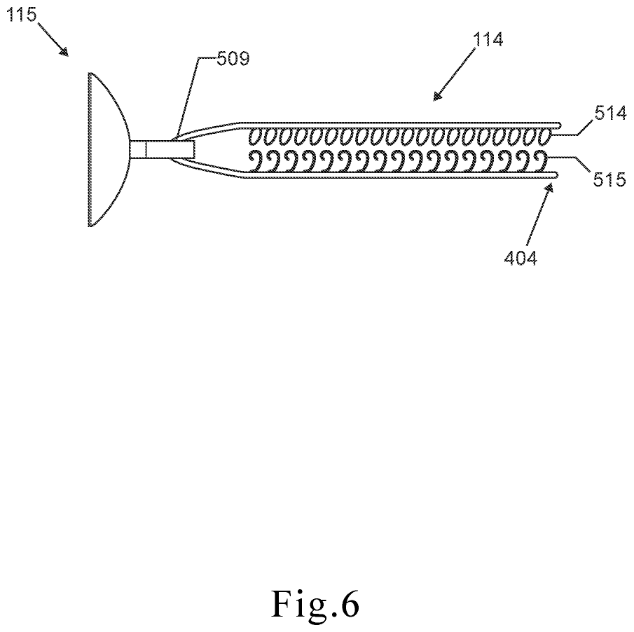

FIG. 6 is an illustration of a close-upside view of one embodiment of connection strap and an attached suction cup. As shown in FIG. 6, the connection strap 114 may comprise a hook 515 and loop 514 material that may be configured to fold over on itself and removably fasten together and removably secure the suction cup 115 in portion 509, which is a suction cup retaining portion. Although a hook 515 and loop 514 material fastener is shown, the connection strap 114 may connect to itself via equivalent devices, such as snaps, buttons, zippers, adhesives, and the like. Preferably the connection strap 114 is attached a security strap at end 404.

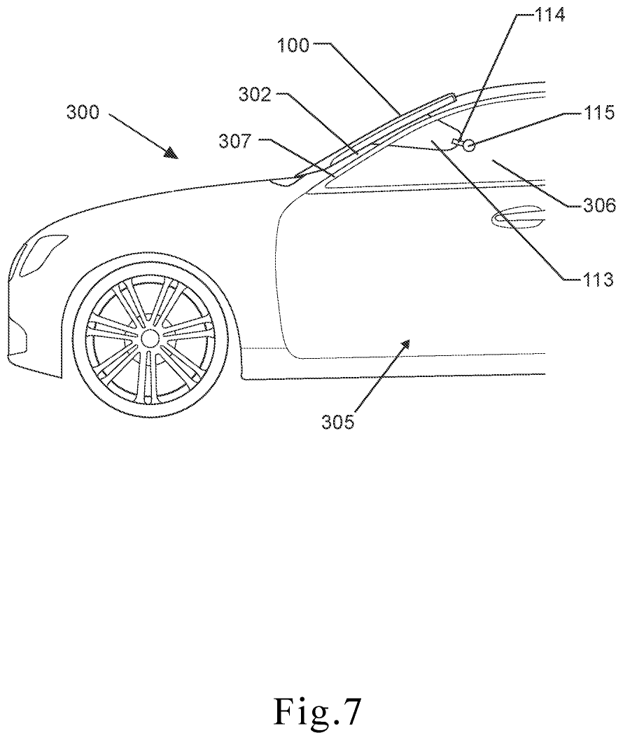

FIG. 7 is an illustration of a side view of one embodiment of the vehicle windshield cover of the present disclosure showing the security strap inserted into the vehicle, and with the suction cup holding the security strap in place on the vehicle's side window. As shown in FIG. 7, the windshield cover 100 may comprise a security strap 113, a connection strap 114, and a suction cup 115. When the door 305 of vehicle 300 is opened, the security strap 113 is passed between the A-frame 302 and the door window frame 307. In that manner, when door 305 is shut, the security strap 113 is trapped in the interior of the vehicle 300 and held substantially in place by the close proximity of the A-frame 302 and the door window frame 307, which typically forms a watertight seal. To keep the security strap 113 in place as the door 305 is shut and after the door 305 is shut, suction cup 115 may be stuck to the interior of window 306. Suction cup 115 may be attached to the security strap 113 via connection strap 114.

FIG. 7 shows how security strap 113 is held securely and taught against the window 306. Alternatively, the security strap may be removably affixed to the interior surface of the windshield, rather than the side window 306. FIG. 7 also shows how security strap 113 may obstruct light and others from seeing clearly through window 306.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the devices, systems, and methods of the present disclosure has been presented for the purposes of illustration and description. While multiple embodiments are disclosed, still other embodiments of the present disclosure will become apparent to those skilled in the art from the above detailed description, which shows and describes illustrative embodiments of the present disclosure. As will be realized, the devices, systems, and methods of the present disclosure is capable of modifications in various obvious aspects, all without departing from the spirit and scope of the present disclosure. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of the present disclosure not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A windshield cover comprising:
a main cover portion;
one or more security straps;
one or more suction cups;
wherein said one or more security straps are connected to one or more edges of said main cover portion, such that said one or more security straps are configured to pass into an interior of a vehicle when said main cover portion is placed on a windshield of said vehicle;
wherein each of said one or more suction cups is attached to one of said one or more security straps;
wherein said one or more suction cups are configured to removably adhere to an interior side of a window of said vehicle, such that each of said one or more security straps are held in place adjacent to said window.

2. The windshield cover of claim 1, wherein each of said one or more suction cups are removably attached to one of said one or more security straps.

3. The windshield cover of claim 1, wherein each of said one or more security straps comprises a connection strap, such that there are one or more connection straps:
wherein each of said one or more connection straps are attached to one of said one or more suction cups.

4. The windshield cover of claim 3, wherein said one or more connection straps are removably attached to one of said one or more suction cups.

5. The windshield cover of claim 4, wherein each of said one or more connection straps comprise a hook and loop material.

6. The windshield cover of claim 5, wherein each of said one or more suction cups comprises a hole, which is configured to allow said one or more connection straps to removably attach to said one or more suction cups.

7. The windshield cover of claim 1, wherein when at least one of said one or more security straps is held in place adjacent to said window, light is at least partially blocked from entering through said window by said at least one of said one or more security straps.

8. The windshield cover of claim 1, wherein when at least one of said one or more security straps is held in place adjacent to said window, visibility into said interior of said vehicle through said window is at least partially blocked by said at least one of said one or more security straps.

9. A windshield cover comprising:
a main cover portion;
two security straps;
two suction cups;
wherein each of said two security straps comprises a connection strap, such that there are two connection straps:
wherein each of said two connection straps are removably attached to one of said two suction cups;
wherein said each of said two security straps are connected to opposite sides of said main cover portion, such that said two security straps are configured to pass into an interior of a vehicle when said main cover portion is placed on a windshield of said vehicle;
wherein each of said two suction cups are configured to removably stick to an interior side of one of two windows of said vehicle, such that said two security straps are held in place, respectively, adjacent to said two windows.

10. The windshield cover of claim 9, wherein each of said two connection straps comprise a hook and loop material.

11. The windshield cover of claim 10, wherein each of said two suction cups comprises a hole, which is configured to allow one of said two connection straps to removably attach to said one or more suction cups.

12. The windshield cover of claim 9, wherein when each of said two security straps is held in place adjacent to one of said two windows, light is at least partially blocked from entering through said two windows by said two security straps.

13. The windshield cover of claim 9, wherein when each of said two security straps is held in place adjacent to one of said two windows, visibility into said interior of said vehicle through said two windows is at least partially blocked by said two security straps.

14. A windshield cover comprising:
a main cover portion;
a security strap;
a suction cup;
wherein said security strap comprises a connection strap;
wherein said connection strap is removably attached to said suction cup;
wherein said security strap is connected to one side of said main cover portion, such that said security strap is configured to pass into an interior of a vehicle when said main cover portion is placed on a windshield of said vehicle;
wherein said suction cup is configured to removably stick to an interior side of a window of said vehicle, such that said security strap is held in place adjacent to said window.

15. The windshield cover of claim 14, wherein said connection strap comprises a hook and loop material.

16. The windshield cover of claim 15, wherein said suction cup comprises a hole, which is configured to allow said connection strap to removably attach to said suction cup.

17. The windshield cover of claim 16, wherein when said security strap is held in place adjacent to said window, light is at least partially blocked from entering through said window by said security strap.

18. The windshield cover of claim 17, wherein when said security strap is held in place adjacent to said window, visibility into said interior of said vehicle through said window is at least partially blocked by said security strap.
